(19) United States
(12) Patent Application Publication
(10) Pub. No.: US 2013/0061714 A1
(43) Pub. Date: Mar. 14, 2013

(54) INERTIAL WHEEL FOR EXERCISE BICYCLE

(71) Applicant: BOB HSIUNG, Taipei City (TW)

(72) Inventor: BOB HSIUNG, Taipei City (TW)

(21) Appl. No.: 13/670,415

(22) Filed: Nov. 6, 2012

Related U.S. Application Data
(63) Continuation-in-part of application No. 13/232,974, filed on Sep. 14, 2011.

(51) Int. Cl. H02K 7/02

(52) U.S. Cl. 74/572.11

(57) ABSTRACT

The inertial wheel contains a circular side piece and a circular frame piece oppositely together. The side piece has its circumference extended towards the frame piece into a first ring wall. The frame piece has its circumference extended towards the side piece into a second ring wall. A ring groove is configured along the second ring wall, and an outer section of the second ring wall presents as a ring platform. The first ring wall of the side piece is received by the ring platform of the second ring wall of the frame piece; and the first and second ring walls are riveted. The inertial wheel is easy to start, with significant inertia, simple to manufacture, less prone to deformation, low cost, low carbon, visually appealing, and wide applicability.

### CROSS-REFERENCE TO RELATED APPLICATION

This application is a continuation-in-part of the co-pending patent application Ser. No. 13/232,974, owned by the same applicant.

### TECHNICAL FIELD OF THE INVENTION

The present invention is generally related to exercise bicycles, and more particular to the inertial wheel used on an exercise bicycle.

### DESCRIPTION OF THE PRIOR ART

The inertial wheel of an exercise bicycle has the following types. Firstly, for those integrally formed from cast iron, they suffer slow production, high material and manufacturing cost, and not environmentally friendly the production process. During their usage, the bicycle frame has to be increased for their heavy weight out of safety concern, leading to cost, transportation, and storage issues. Their heavy weight also makes weak or slim users difficult to start exercising.

Secondly, for those made from plastic material by composite forming, which has obviated the weight problem of the previous type but suffers easy deformation from external impact and as such low operation stability resulted from their deformation. Their lack of proper weight as well as inertia cannot provide effective exercising effect. As such, they are usually installed on smaller exercise bikes, leading to limited applicability.

Thirdly, for those made by stamping and welding thin steel plates, their wheel body consists of two pieces and each is formed by stamping. The two pieces are then welded oppositely together with optional weight material housed inside. Further cutting and polishing at the welding interface is usually required. This type of inertial wheels, despite that they obviate the major drawbacks of the other two types, still suffer problems such as low efficiency from manual welding, high equipment cost from automatic welding apparatus, deformation from welding, complicated production process, and higher cost. In the meantime, their being made from stamped steel plates leads to insufficient structural strength.

People's Republic of China Patent No. CN201227499 discloses an inertial wheel consisting of a left casing and a right casing. The left casing is welded or riveted to the left side of a support frame and the right casing is bolted to a right side. The hollow chamber formed between the left, right casings and the support frame is filled with materials of various specific weights. This inertial wheel overcomes problems like deformation and loud noise. However its consisting of several major parts leads to structural complexity, and additional material requirement from the inclusion of the support frame. The production process also involves multiple steps of alignment, riveting, and bolting, leading to tedious production process and increased material and production cost.

In general, conventional inertial wheels, regardless of their types, are limited by material characteristics, structural design, and/or production technique, and cannot satisfy the requirements of high inertia, high structural strength, light weight, easy starting up, low material cost, and convenient production simultaneously.

### SUMMARY OF THE INVENTION

A major objective of the present invention is therefore to provide an inertial wheel for exercise bicycles that provides enhanced inertia and reduced wind resistance during operation, thereby leading to easier starting up and wider applicability.

Another major objective of the present invention is to provide an inertial wheel for exercise bicycles that has a simplified structure and parts, effectively reducing its weight and material requirement, achieving easier manufacturing and assembly, simplifying production process, and reducing material and production cost.

Yet another major objective of the present invention is to provide an inertial wheel for exercise bicycles that has enhanced structural strength and operation reliability over an extended operation life span.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of an inertial wheel according to a first embodiment of the present invention.

FIG. 2 is a perspective diagram showing the inertial wheel of FIG. 1 after its assembly.

FIG. 3 is a side-view diagram showing the inertial wheel of FIG. 1. FIG. 4 is a sectional diagram showing the inertial wheel of FIG. 1 if the inertial wheel is cut along the A-A line of FIG. 3.

FIG. 5 is a sectional diagram showing a part of the inertial wheel of FIG. 1 marked as ‘a’ in FIG. 4.

FIG. 6 is a sectional diagram showing an inertial wheel according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

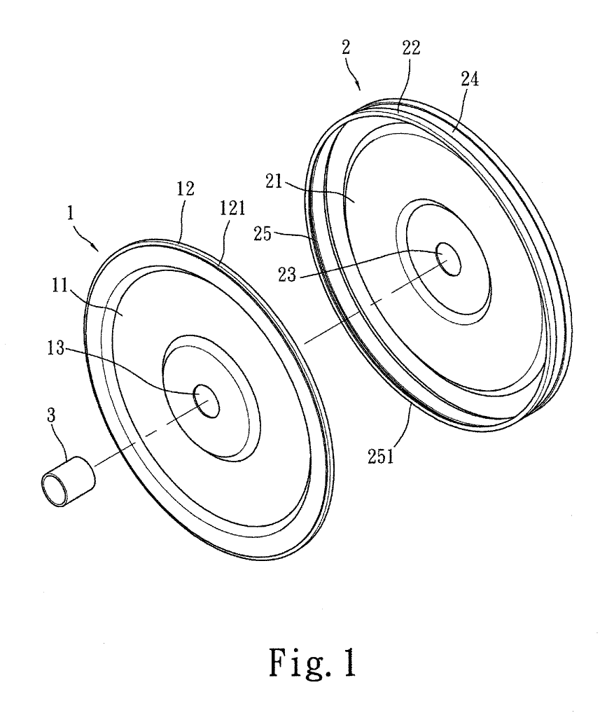

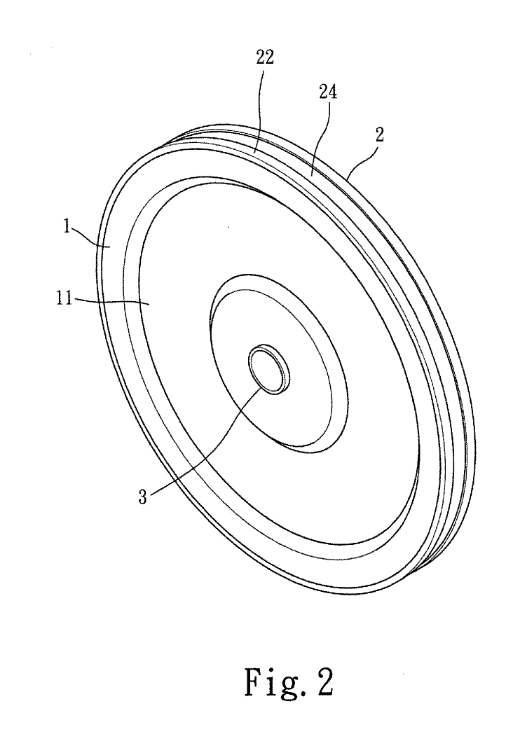

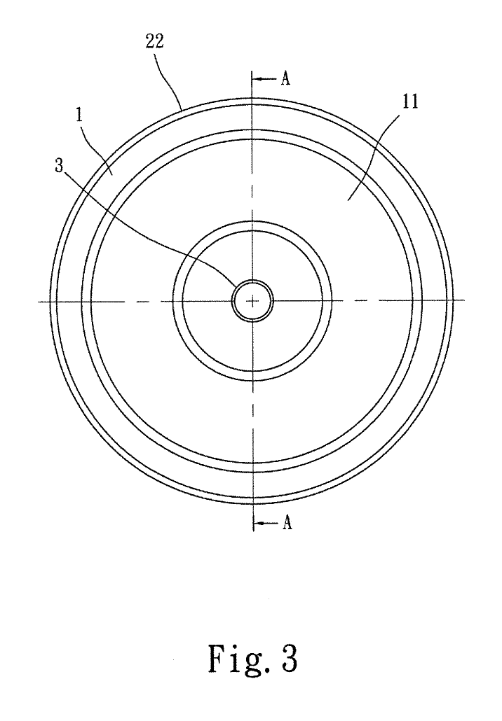

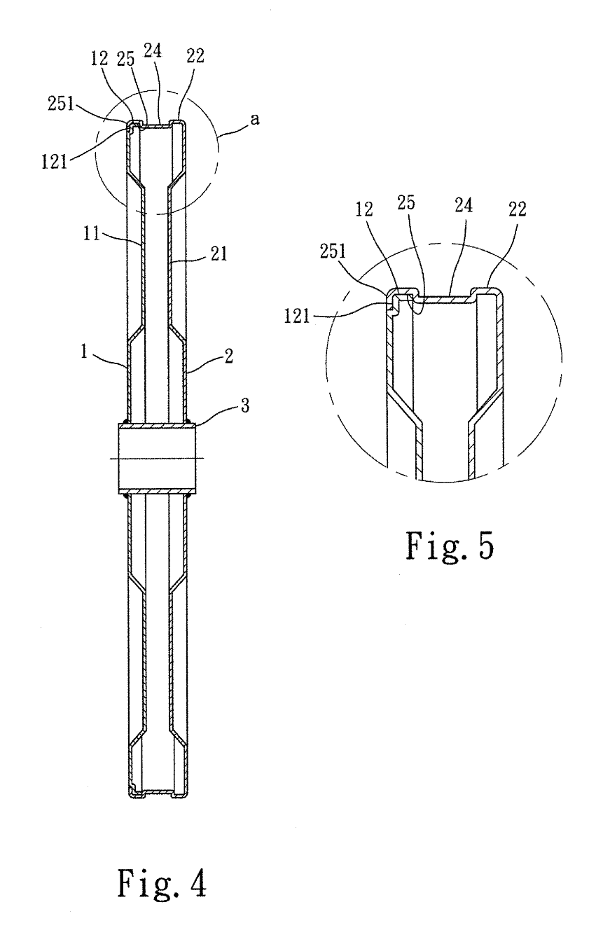

As shown in FIGS. 1 to 5, an inertial wheel according to a first embodiment of the present invention contains a circular side piece 1 and a circular frame piece 2. The circular side piece 1 and the circular frame piece 2 are oppositely joined together.

The center of the side piece 1 has a through hole 13 and, between the through hole 13 and the circumference of the side piece 1, the side piece 1 has a first ring indentation 11 concaved towards the frame piece 2. The circumference of the side piece 1 forms a first ring wall 12 extending towards the frame piece 2. An indented ring step 121 is formed between the first ring wall 12 and an outer side of the side piece 1 for coupling the frame piece 2.

The center of the frame piece 2 has a through hole 23 corresponding to the through hole 13 of the side piece 1. Between the through hole 23 and the circumference of the frame piece 2, the frame piece 2 has a second ring indentation 21 concaved towards the side piece 1. The first and second ring indentations 11 and 22 have matched width and depth. The circumference of the frame piece 2 forms a second ring wall 22 extending towards the side piece 1. Along the second ring wall 22, there is a ring groove 24. An outer section of the second ring wall 22 as such presents as a ring platform 25. An outer edge along the ring platform 25 forms a positioning element 251 to limit the first ring wall 12. As such, when the side and frame pieces 1 and 2 are joined oppositely together, the first ring wall 12 is received by the ring platform 25 of the second ring wall 22, and the positioning element 251 of the second ring wall 22 is bended inward to cover the ring step 121 of the first ring wall 12. After the side and frame pieces 1 and 2 are joined, the two are riveted together.

An axle tube 3 runs through the matching and aligned circular through holes 13 and 23 at the centers of the side and frame pieces 1 and 2. The axle tube 3 is for an axle of an exercise bicycle to thread through.

As described above, the side and frame pieces 1 and 2 are joined mainly by the compatible first and second ring walls 12 and 22. Additionally, by locking the ring step 121 of the first ring wall 12 by the positioning element 251 on the ring platform 25 of the second ring wall 22, the side and frame pieces 1 and 2 then can be riveted together directly. There is no need for a support frame and welding. The production efficiency therefore can be greatly enhanced and the production cost is significantly reduced. The production process also does not produce any contaminants, conforming to current low-carbon product requirement.

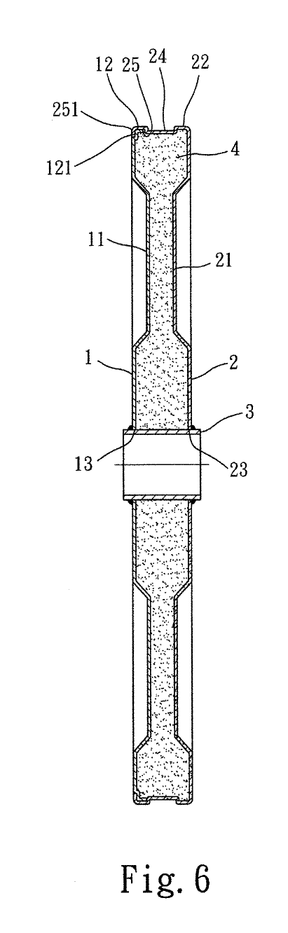

FIG. 6 shows an inertial wheel according to a second embodiment of the present invention. The difference from the first embodiment lies in that fillers 4 of various weights are stored in a chamber formed between the side and frame pieces 1 and 2, so as to increase the weight and inertia of the inertial wheel and its applicability to various exercise bicycles. Please note that the fillers 4 can be added before or after the side and frame pieces 1 and 2 are riveted.

To assemble the inertial wheel, fillers 4 of different weights are first placed on the side and frame pieces 1 and 2. Then the first ring wall 12 of the side piece 1 is plugged into the ring platform 25 of the second ring wall 22. The positioning element 251 of the second ring wall 22 is bended inward to tightly press against and then riveted to the ring step 121 of the first ring wall 12. Finally the axle tube 3 is pushed into and welded to the through holes 13 and 23. A complete inertial wheel is as such formed.

The fillers 4 are for increasing the weight and inertia of the inertial wheel so that it could be adapted to the requirements of various exercise bicycles. The inertial wheel of the present invention therefore enjoys a broad applicability.

The inertial wheel of the present invention the following advantages in terms of manufacturing and usage.

Firstly, the first and second ring indentations 11 and 21 on the side and frame pieces 1 and 2, together with the ring groove 24 around the frame piece 2 provide the inertial wheel more stereographic and appealing appearance. The indentations 11 and 21 also greatly enhance the inertial wheel's structural strength, thereby avoiding the use of a support frame which is required by the conventional inertial wheel.

Secondly, with the matching ring platform 25 of the second ring wall 22 on the fame piece 2 and the first ring wall 12 of the side piece 1, the side and frame pieces 1 and 2 are directly joined together without the use of a support frame and welding. The production efficiency is thereby greatly enhanced and the overall production cost of the inertial wheel is significantly reduced.

Thirdly, the first and second ring indentations 11 and 21 on the side and frame pieces 1 and 2 can not only reduce the fillers 4 in the chamber, but also allow the inertial wheel to start more easily. Also the inertial wheel as such weighs more around its circumference, thereby leading to greater inertia and reduced wind resistance.

Fourthly, the inertial wheel has simplified structure and parts. Not only that its weight is effectively reduced, but also that it has reduced material, is easy to produce and assemble with simplified process, and can effectively reduce the material and production cost.

Fifthly, the inertial wheel provides greater structural strength for enhanced reliability and extended operation life span.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An inertial wheel for an exercise bicycle, comprising a circular side piece and a circular frame piece oppositely together; wherein
the side piece has a first ring indentation between the center and the circumference of the side piece concaved towards the frame piece;
the side piece has its circumference extended towards the frame piece into a first ring wall;
the frame piece has a second ring indentation between the center and the circumference of the frame piece concaved towards the side piece; the frame piece has its circumference extended towards the side piece into a second ring wall; a ring groove is configured along the second ring wall; an outer section of the second ring wall as such presents as a ring platform;
the first ring wall of the side piece is received by the ring platform of the second ring wall of the frame piece; and the first and second ring walls are riveted.

2. The inertial wheel according to claim 1, wherein matching and aligned through holes are configured at the centers of the side and frame pieces, respectively; and an axle tube is threaded through and positioned in the through holes.

3. The inertial wheel according to claim 3, wherein an indented ring step is formed between the first ring wall and an outer side of the side piece; an outer edge along the ring platform forms a positioning element; the positioning element of the second ring wall is bended inward to cover the ring step of the first ring wall.

4. The inertial wheel according to claim 1, wherein the first and second ring indentations have matched width and depth.

5. The inertial wheel according to claim 1, wherein a plurality of fillers of different weights are stored in a chamber formed between the side and frame pieces.
